(19) United States
(12) Patent Application Publication
(10) Pub. No.: US 2026/0275884 A1
(43) Pub. Date: Sep. 17, 2026

(54) GUIDE DEVICE FOR AN AIRCRAFT TURBINE ENGINE

(71) Applicant: SAFRAN AIRCRAFT ENGINES, Paris (FR)

(72) Inventors: Remy LE GALL, Moissy-Cramayel (FR); Daniele CACCIAPUOTI, Moissy-Cramayel (FR)

(21) Appl. No.: 19/161,997

(22) PCT Filed: Feb. 23, 2024
(86) PCT No.: PCT/FR2024/050239

§ 371 Date: Sep. 3, 2025

(30) Foreign Application Priority Data
Mar. 3, 2023 (FR) FR2301987

(51) Int. Cl. F01D 25/24; B64D 27/10; F01D 25/28

(52) U.S. Cl. CPC F01D 25/24; B64D 27/10; F01D 25/28; F05D 2220/323; F05D 2230/23

(57) ABSTRACT

A guide device for an aircraft turbine engine, the guide device includes a metal body provided with at least one attachment tab including an opening configured to receive a screw or the like; a guide pad made of a plastic or composite material, this pad provided with a first surface bonded to a first surface of the body and a second opposing surface which is free and which is configured to form a sliding guide surface, wherein the metal body includes through-holes which open onto the first surface of the body and in that the guide pad includes studs which project from the first surface of the pad and which are respectively engaged and crimped in the holes of the body.

### TECHNICAL FIELD OF THE INVENTION

The present invention relates to the general field of aeronautic. More specifically, it relates to a guide device for an aircraft turbine engine, an aircraft turbine engine comprising one or more guide devices, and a method of manufacturing this device.

### TECHNICAL BACKGROUND

The technical background includes in particular the documents US-A1-2014/050567, US-A1-2012/195755, US-A1-2009/038739 and US-A1-2004/062641.

In this application, a guide device is understood to be a device capable of guiding a movable element, in particular by sliding or friction. The element is therefore designed to slide or rub on the guide device as it moves.

A turbine engine can include different types of guide devices.

For example, we are familiar with control ring guide devices for a VBV (Variable Bleed Valve) systems or VSV (Variable Stator Valve) systems.

A control ring extends around an annular casing of the turbine engine and guide devices are attached to the casing and serve to guide the control ring as it moves around and/or along the casing.

In a LSV system, the control ring is connected to discharge valves. In a VSV system, the control ring is connected to variable pitch stator vanes.

Although the following description details a VBV system, the invention is not limited to this application.

Among the existing technologies of guide devices, the invention relates to a guide device comprising a metal body and a guide pad bonded to the metal body and on which the movable element such as the control ring is able to slide.

The metal body is generally attached to a casing and comprises at least one attachment tab comprising an orifice configured to receive a screw or the like.

The guide pad is made of a plastic material and is glued to the body. This pad comprises a surface free of sliding guides.

The control ring slides on the guide pad as it moves. The pad facilitates the sliding of the ring and, thanks to a relatively low coefficient of friction, ensures smooth sliding with the ring.

This guide device technology is relatively simple, inexpensive and fulfils its purpose. However, the experience in use has shown that there is a limit to the use of the guide pad.

There is, in fact, a risk that the guide pad may come loose and separate from the body, which could result in the guide pad being lost in the engine. In fact, the relative movements between the ring and the guide pad generate shear forces at the interface between the pad and the body, which eventually cause partial and then total delamination of the guide pad.

To date, due to the poor accessibility of the devices, the detachment of the guide pads observed under the wing cannot be repaired at this level of inspection. Thus, when detachments exceed the acceptable criteria, the ring loses support on the guide device, which may alter the synchronization of the kinematics and therefore impact the opening and closing of the valves. The guide device must then be removed for repair.

The innovation aims to offer a solution that allows resolving this technical problem and provides a more reliable solution than the current one.

### SUMMARY OF THE INVENTION

The invention relates to a guide device for an aircraft turbine engine, comprising:
a metal body comprising at least one attachment tab including an orifice configured to receive a screw or the like, this metal body comprising a first surface,
a guide pad which is made from a plastic or composite material, this pad comprising a first surface bonded to said first surface of the body and an opposite second surface which is free and is configured to form a sliding guide surface,
characterized in that said metal body comprises through holes which open onto the first surface of the body, and in that said guide pad comprises studs which project from said first surface of the pad and which are respectively engaged and crimped in the holes of said body.

The guide pad of the guide device according to the invention is crimped onto the body as well as being bonded to it. The pad is therefore double-attached to the body, which greatly reduces the risk of one becoming detached from the other. Even if the pad comes off, the guide pad remains secured to the body thanks to the crimping. This crimping is achieved by means of studs on the pad that engage with holes in the body.

The guide device according to the invention may also comprise one or more of the following characteristics, taken alone or in combination with each other:
each of the studs passes through one of said holes and comprises a free end deformed by crimping and bearing on a second surface of the body opposite its first surface;
the free end is deformed by melting of said material of the guide pad;
the deformed free end of each stud has a diameter or the transverse dimension greater than the diameter or transverse dimension of the remainder of this stud and of the hole through which this stud passes;
the guide pad is made of PTFE;
the number of studs is between 3 and 10; this number is chosen according to the space available, for example;
the number of studs is three or four:
   the studs are not aligned;
   the studs are lined up two by two;
the pad has a curved or arched shape;
   the guide pad is formed in one piece with its studs;
   the guide pad is in the form of a flat or curved plate that comprises two main surfaces, with the studs protruding from one of these main surfaces, which form said second surface of the pad, and the other of these main surfaces forming the first surface of the pad;
   each of the studs is longer than a length or depth of the holes so that the free end of each stud projects beyond the hole through which that stud passes.

The invention also relates to an aircraft turbine engine, comprising an annular casing, a control ring extending around the casing, and guide devices as described herein which are attached to the casing and interposed between the casing and the control ring, the control ring being slidable on the guide surfaces of the devices.

In one embodiment of the invention, the casing includes through openings for gas passage, and the control ring is connected to discharge valves which are moved by the control ring from a first closing position of these openings to an open position of these openings.

The present invention also relates to a method of manufacturing a device as described above, in which it comprises the following steps:
a) making the metal body and the guide pad, this guide pad comprising studs projecting from its first surface which have a constant diameter or transverse dimension over their entire length,
b) gluing the first surface of the body and/or the first surface of the guide pad,
c) mounting the guide pad on the body by engaging the studs of the guide pad in the holes of the body and applying the first surface of the guide pad to the first surface of the body, and
d) crimping the studs so that their free ends have a diameter or transverse dimension greater than the diameter or transverse dimension of the remainder of these studs.

The method according to the invention may also comprise one or more of the following characteristics, taken alone or in combination with each other:
the method comprises, between steps a) and b), a step i) of shaping and in particular curving the guide pad;
step d) is carried out by heating and melting the free ends of the studs;
step d) is carried out by applying a distal end of a heating tool, such as a soldering iron, to the free end of each of the studs, this distal end comprising a flat surface which is intended to bear on the body and which comprises a cylindrical housing for receiving this free end;
   the distal end is generally cylindrical;
   prior to step d), each of the studs has a length which protrudes from the hole through which it passes, which is greater than a depth of said housing;
   said housing has an internal diameter which is greater than the diameter of the studs prior to step d).

### BRIEF DESCRIPTION OF THE FIGURES

Further characteristics and advantages of the invention will become apparent from the following detailed description, for the understanding of which reference is made to the attached drawings in which:

FIG. 1 is a schematic axial sectional view of an aircraft turbine engine;

FIG. 2 is a schematic half-view in axial section of a compressor and an intermediate casing of an aircraft turbine engine, this intermediate casing being fitted with a VBV system;

FIG. 3 is a larger-scale schematic view of the VBV system shown in FIG. 2;

FIG. 4 is a schematic perspective view of an VBV system for an aircraft turbine engine;

FIG. 5 is a schematic perspective view of a guide device according to one embodiment of the invention;

FIG. 6 is a schematic front view of the metal body of the guide device in FIG. 5;

FIG. 7 is a schematic perspective view of the metal body of the guide device in FIG. 5;

FIG. 8 is a schematic perspective view of the guide pad of the guide device in FIG. 5, before mounting or bending;

FIG. 9 is a schematic side view of the guide pad of the guide device in FIG. 5, after mounting or bending and before crimping;

FIG. 10 is a schematic front view and transparent view of the guide device shown in FIG. 5, after the guide pad has been mounted on the metal body;

FIG. 11 is a schematic perspective view of the guide device in FIG. 5, after the guide pad has been mounted on the metal body;

FIG. 12 is a schematic partial perspective view of the guide device of FIG. 5 and a crimping tool, and illustrates another stage in the manufacture of this device;

FIG. 13 is a schematic perspective view of the tool shown in FIG. 12;

FIG. 14 is a schematic cross-sectional view of a guide device and a heating crimping tool, and illustrates a step in the manufacture of the device; and

FIG. 15 is a schematic transparent perspective view of a guide device after the crimping step.

### DETAILED DESCRIPTION OF THE INVENTION

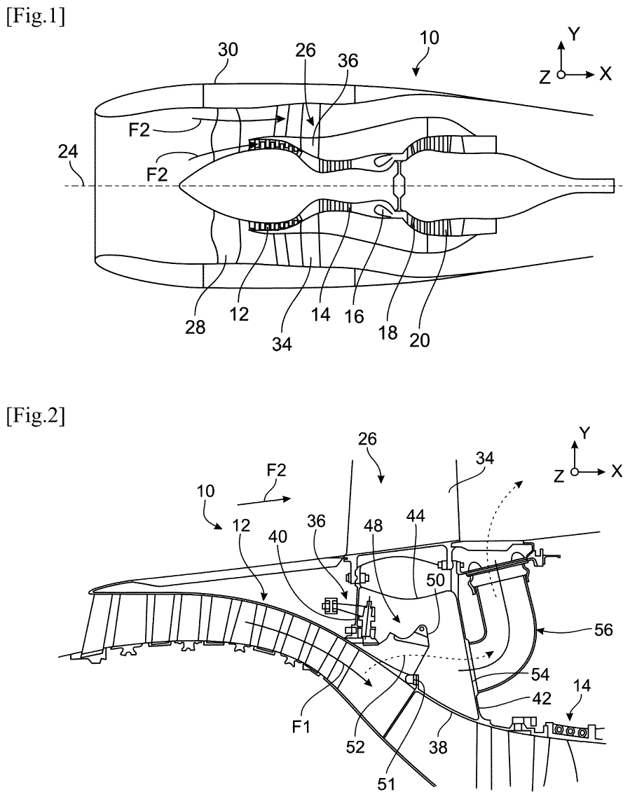

In the present invention, and in general, the terms “upstream”, “downstream”, “axial” and “axially” are defined in relation to the flow of gases in a turbine engine and here along the longitudinal axis X (and even from left to right in FIG. 1) of this turbine engine. Similarly, the terms “radial”, “internal” and “external” are defined in relation to a radial axis Y perpendicular to the longitudinal axis X and in relation to the distance from the longitudinal axis X.

As shown in FIG. 1, which is a schematic axial cross-sectional view of a dual flow or two-spool turbine engine 10, such a turbine engine generally comprises, from upstream to downstream in the direction of gas flow, a low-pressure compressor 12, a high-pressure compressor 14, an annular combustion chamber 16, a high-pressure turbine 18 and a low-pressure turbine 20, which define a flow duct for a primary gas flow F1.

The rotor of the high-pressure turbine 18 is secured to the rotor of the high-pressure compressor 14 so as to form a high-pressure body, and the rotor of the low-pressure turbine 20 is secured to the rotor of the low-pressure compressor 12 so as to form a low-pressure body. The rotor of each turbine drives the rotor of the associated compressor in rotation about the longitudinal axis 24 of the turbine engine under the effect of the thrust of the gases coming from the combustion chamber 16.

In such a turbine engine 10, an intermediate casing 26 is usually interposed between the low-pressure compressor 12, located upstream, and the high-pressure compressor 14, located downstream. The intermediate casing 26 is generally annular in shape.

In the case of dual flow turbine engines, which comprise a fan 28 ducted by a nacelle 30 to generate a secondary flow F2, the intermediate casing 26 generally comprises arms 34 passing through the duct of this secondary flow F2.

FIG. 2 shows a simplified view of an intermediate casing 26 on which discharge valves 48 are mounted at the hub 36 of the intermediate casing 26. This hub 36 comprises two coaxial annular shells, respectively internal 38 and external 44, and two radial walls or flanges, respectively upstream 40 and downstream 42, connecting the internal 38 and external 44 shells. The internal shell 38 delimits the external part, with respect to the axis 24, of the primary flow space, or primary duct, of the primary duct F1 of the turbine engine.

This hub 36 is also fitted with an annular row of discharge valves 48, one of which can be seen in cross-section in FIG. 2. This figure shows more specifically the door 50 of the valve 48, which is mounted so as to pivot about an axis 51, so as to be movable between an open position and a closed position of a corresponding opening 60 formed in the internal shell 38 of the hub 36.

Each of the discharge air inlet openings 60, which are substantially parallelepipedic in shape, is associated with a discharge valve 48 designed to regulate the flow rate of the high-pressure compressor 14.

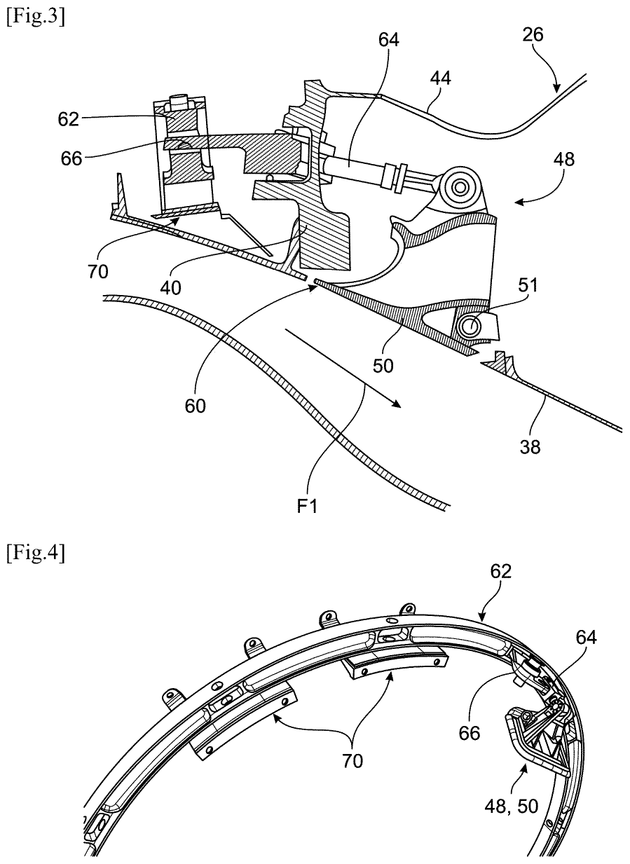

A system for controlling the opening and closing of the discharge valves 48, commonly known as the VBV system, is more clearly visible in FIG. 3 and comprises a control ring 62 for controlling the opening and closing of the discharge valves 48 as a function of the operating conditions of the turbine engine. This ring 62 is centered on the longitudinal axis 24 of the turbine engine 10 and placed in the space outside the shell 38.

The control ring 62 is set in motion by actuators (not shown) which are also located outside the shell 38. The rotation of the control ring 62 activates actuating devices that drive the discharge gates 50. An actuating device is associated with each discharge gate 50 and comprises a connecting rod 64, one end of which is connected to the discharge gate 50 and the opposite end of which is connected by a bell crank 66 to the control ring 62, so as to transform the movement of the ring 62 around and/or along the axis 24 into a pivoting and opening/closing movement of the door 50. Each bellcrank 66 is articulated about a substantially radial axis.

The opening of each valve 48 causes an air flow (dotted arrow 52 in FIG. 2) to be discharged into the annular space delimited by the shells 38, 44 and the radial walls 40, 42.

The downstream radial wall 42 delimits the internal part relative to the axis X of the flow space in the secondary duct, of the secondary flow F2. The wall 42 comprises an annular row of orifices 54 for the downstream passage of discharge air flows 52. As can be seen in FIG. 2, discharge pipes 56 are mounted downstream of the intermediate casing 26 and are each designed to guide an air flow 52 caused by the opening of a discharge valve 48, the air flow being guided from the outlet of the orifices 54 to the flow duct of the secondary flow F2.

FIGS. 3 and 4 show devices 70 for guiding the control ring 62 during its movements.

The guide devices 70 are attached to the intermediate casing 26 and in particular to the inner shell 38 in the example shown. The guide devices 70 are inserted between the shell 38 and the ring 62, which can slide on the guide devices 70 as it moves.

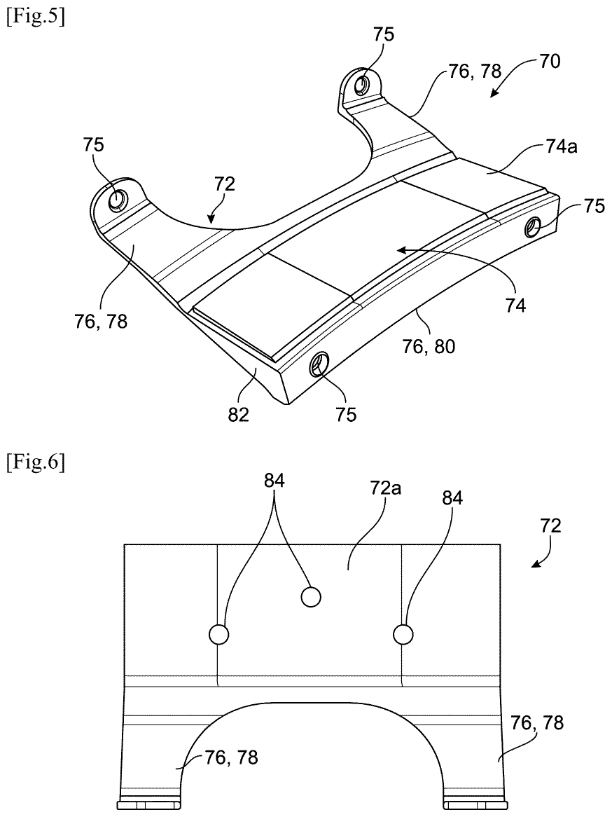

FIG. 5 and following illustrate an embodiment of a guide device 70 according to the invention.

This guide device 70 essentially comprises two parts, namely a metal body 72 and a guide pad 74 attached and bonded to the metal body 72.

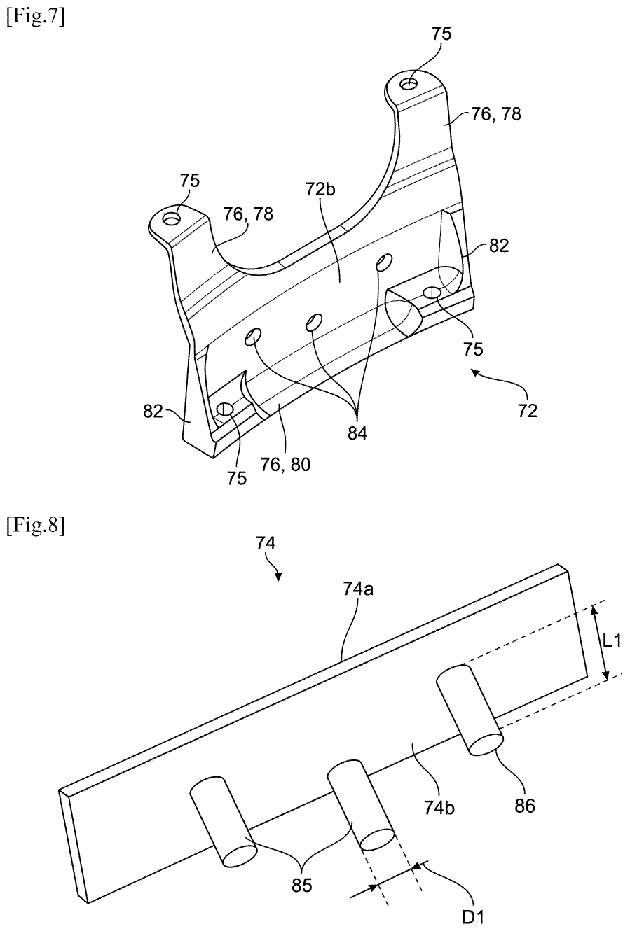

The metal body 72 is shown on its own in FIGS. 6 and 7.

The metal body 72 is attached to the casing 26 by means of screws or similar such as bolts or rivets. It therefore includes one or more orifices 75 for the passage of these screws or the like.

The orifices 75 may be formed in one or more attachment tabs 76 on the body 72.

In the example shown, the body 72 includes a generally rectangular plate comprising two parallel long sides and two parallel short sides. Two L-shaped tabs 78 project from one of these long sides, and the other long side comprises a rim 80 or is folded to form a tab 76, which extends along the entire length of this long side. Each of the tabs 78 comprises an orifice 75 and the rim 80 comprises two orifices 75. Each of the short sides may also include stiffeners 82 as shown in the drawings.

The body 72 comprises two opposing surfaces 72a, 72b. In the example shown, these surfaces 72a, 72b are those of the aforementioned plate and each has a generally rectangular shape.

These surfaces 72a, 72b are advantageously smooth and can be plane or slightly curved. In the latter case, the surface 72a is convexly curved and the surface 72b is concavely curved.

As can be seen in the drawings, the body 72 comprises through holes 84 which open onto surfaces 72a, 72b.

The number of holes 84 is three, although this number is not limitative.

The holes 84 are not aligned along the same straight line.

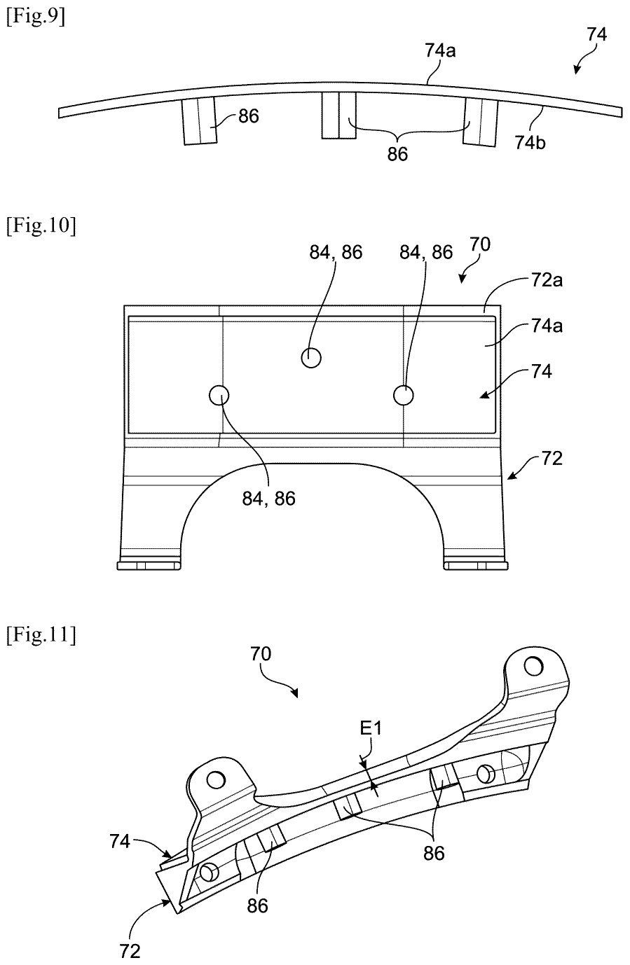

The guide pad 74 is shown on its own in FIGS. 8 and 9.

The guide pad 74 is attached to the metal body 72 by bonding and crimping. The guide pad 74 is bonded to the surface 72a of the body 72 and partially or completely covers this surface 72a.

In the example shown, the guide pad 74 comprises a generally rectangular plate comprises two parallel long sides and two parallel short sides. The dimensions of the plate of the pad 74 are preferably identical or close to those of the plate of the body 72.

The guide pad 74 comprises two opposing surfaces 74a, 74b. In the example shown, these surfaces 74a, 74b are those of the aforementioned plate and each has a generally rectangular shape.

These surfaces 74a, 74b are advantageously smooth and can be flat or slightly curved. In the latter case, the surface 74a is convexly curved and the surface 74b is concavely curved (see FIG. 9).

The surface 74a is intended to remain free and forms the sliding surface of the control ring 62 in the aforementioned application.

The surface 74b is designed to be bonded to and cover the surface 72a of the body.

The guide pad 74 comprises projecting studs 86 which are designed to be engaged and crimped into the holes 84 in the metal body 72. The studs 86 project from the surface 74b of the pad 74.

The studs 86 have positions and dimensions that allow them to be inserted into the holes. It is therefore clear that, in the example shown, there are three studs 86 and they are not aligned.

The studs 86 can have a generally cylindrical shape before crimping. They therefore each have a constant diameter D1 along their entire length L1. The length L1 of the studs is preferably greater than the thickness E1 of the body 72 and in particular of its plate, so that the studs 86 of the pad 74 pass completely through the holes 84 in the body 72.

The guide pad 74 is preferably made of PTFE (polytetrafluoroethylene).

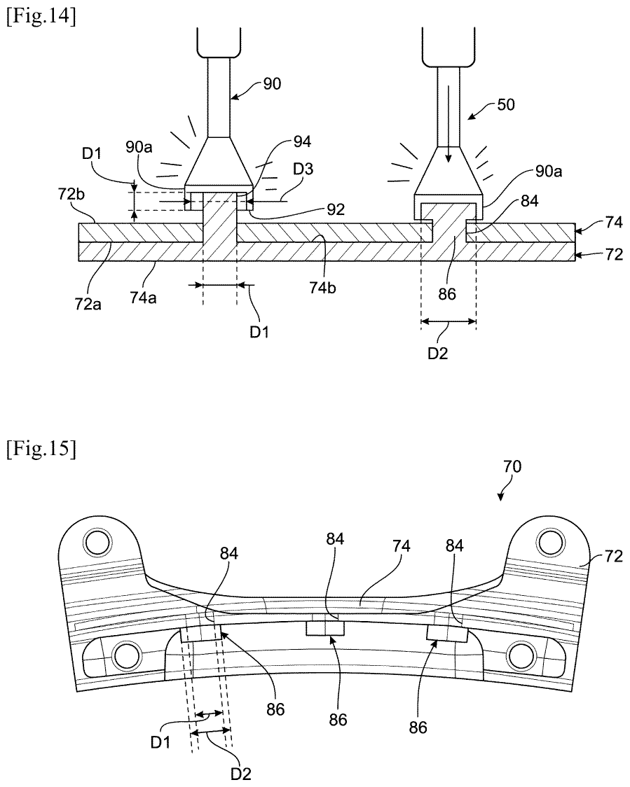

FIGS. 10 to 14 illustrate the steps of a manufacturing method according to the invention and FIG. 15 illustrates the guide device 70 obtained at the end of this method.

FIG. 15 shows that each of the studs 86 passes through one of the holes 84 and comprises a free end deformed by crimping and resting on the surface 72b of the body 72. As will be described below, the free end is preferably deformed by melting the material of the guide pad 74. The deformed free end of each stud 86 has a diameter D2 greater than the diameter D1 of the rest of this stud 86 and of the hole 84 through which this stud passes, which ensures that the guide pad 74 is retained with respect to the metal body 72.

We will now describe an embodiment of a method for manufacturing a guide device 70 with reference to FIGS. 10 to 13.

The method comprises a first step a) of producing the metal body 72 and the guide pad 74.

The metal body 72 is, for example, produced by casting or machining. The guide pad 74, for example, is produced by molding. The holes 84 can be made directly during the manufacture of the body 74, or afterwards, for example by drilling.

The method may include a subsequent step i) of shaping the guide pad 72. This shaping is preferably a bending or curving of the guide pad 74 and in particular its plate, as shown in FIG. 9, so that it has a curvature similar to that of the body 72 and in particular its surface 72a.

The method comprises a second step b) of gluing surface 72a of the body 72 and/or surface 74b of the pad 74. The adhesive is, for example, of the epoxy or polyurethane type, although this is not restrictive.

The method comprises a third step c) of mounting the guide pad 74 on the body 72 by engaging the studs 86 of the guide pad 74 in the holes 84 of the body 72 and applying the surface 74b of the guide pad 74 to the surface 72a of the body 72. This produces the assembly illustrated in FIGS. 10 and 11, in which the free ends of the studs 86 preferably project from the surface 72b of the body.

The method comprises a fourth step d) of crimping the studs 86 so that their free ends have a diameter D2 greater than the diameter D1 of the rest of these studs.

Step d) is preferably carried out by heating and melting the free ends of the studs 86. Alternatively, it could be achieved by plastic deformation of these free ends.

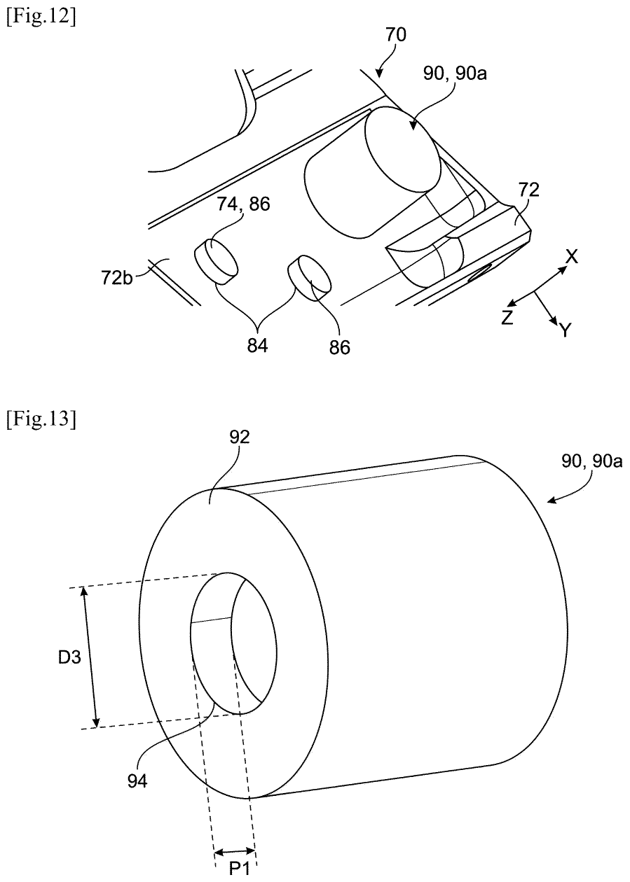

As illustrated in FIGS. 12 to 14, step d) may be performed by applying a distal end 90a of a heating tool 90, such as a soldering iron, to the free end of each of the studs 86. The distal end 90a preferably has a flat surface 92 which is intended to rest on the surface 72b of the body 72 and which comprises a cylindrical housing 94 for receiving the free end of the stud 96.

In the example shown, the distal end 90a has a generally cylindrical shape and the flat surface 92 is circular or annular, the housing 94 being centered on this surface 92.

In step d), the free end of the stud 86 is engaged in the housing 94 and heated above the melting point (approximately 327° C. for PTFE) of the material of the pad 74. The tool 90 is moved until its surface 92 rests on the body 72 so as to fold the softened material onto the surface 72b of the body, thereby deforming the free end of the stud 86. It is therefore understood that the depth P1 of the housing 94 is preferably less than the length L2 of each stud 86 which projects from the surface 72b of the body. After crimping, the length L2′ of each stud projecting from the surface 72b is approximately equal to the depth P1 of the housing 94. To allow deformation of the free end, it is also understood that the diameter D3 of the housing 94 is preferably greater than the diameter D1 of the stud 86 before crimping. After crimping, the free end of the stud has a diameter D2 equivalent to the diameter D3 of the housing 94.

1. A guide device for an aircraft turbine engine, comprising:
a metal body comprising at least one attachment tab including an orifice (75) configured to receive a screw or the like, this metal body comprising a first surface,
a guide pad which is made from a plastic or composite material, this pad comprising a first surface bonded to said first surface of the body and a second opposite surface which is free and which is configured to form a sliding guide surface,
wherein said metal body comprises through holes which open onto the first surface of the body, and in that said guide pad comprises studs which project from said first surface of the pad and which are respectively engaged and crimped in the holes of said body.

2. The device according to claim 1, wherein each of the studs passes through one of said holes and comprises a free end deformed by crimping and bearing on a second surface of the body opposite its first surface.

3. The device according to claim 2, wherein the free end is deformed by melting of said material of the guide pad.

4. The device according to claim 2, wherein the deformed free end of each stud has a diameter or transverse dimension greater than the diameter or the transverse dimension of the remainder of this stud and of the hole through which this stud passes.

5. The device according to claim 1, wherein the guide pad is made of PTFE.

6. The device according to claim 1, wherein the number of studs is between 3 and 10.

7. The device according to claim 6, wherein the number of studs is three or four.

8. The device according to claim 1, wherein the pad has a curved or arched shape.

9. An aircraft turbine engine, comprising an annular casing, a control ring extending around the casing, and guide devices according to claim 1 which are attached to the casing and interposed between the casing and the control ring, the control ring being able to slide on the guide surfaces of the devices.

10. The turbine engine as claimed in claim 9, wherein the casing includes through openings for gas passage, and the control ring is connected to discharge valves which are moved by the control ring from a first closed position of these openings to an open position of these openings.

11. A method of manufacturing a device according to claim 1, wherein it comprises the following steps:
a) making the metal body and the guide pad, this guide pad comprising studs projecting from its first surface which have a constant diameter or transverse dimension over their entire length,
b) gluing the first surface of the body and/or the first surface of the guide pad,
c) mounting the guide pad on the body by engaging the studs of the guide pad in the holes of the body and applying the first surface of the guide pad to the first surface of the body, and
d) crimping the studs so that their free ends have a diameter or transverse dimension greater than the diameter or transverse dimension of the remainder of these studs.

12. The method according to claim 11, wherein it comprises, between steps a) and b), a step i) of shaping and in particular curving the guide pad.

13. The method according to claim 11, wherein step d) is carried out by heating and melting the free ends of the studs.

14. The method according to claim 13, wherein step d) is carried out by applying a distal end of a heating tool, such as a soldering iron, to the free end of each of the studs, this distal end comprising a flat surface which is intended to bear on the body and which comprises a cylindrical housing for receiving this free end.
